(19) United States
(12) Patent Application Publication
(10) Pub. No.: US 2026/0299961 A1
(43) Pub. Date: Oct. 1, 2026

(54) MULTI-CLUSTER ARCHITECTURE FOR A HARDWARE INTEGRATED CIRCUIT

(71) Applicant: Google LLC, Mountain View, CA (US)

(72) Inventors: Suyog Gupta, Sunnyvale, CA (US); Ravi Narayanaswami, San Jose, CA (US); Hongil Yoon, San Jose, CA (US); Alekhya Perugupalli, San Jose, CA (US); Bhuvana Kurady Bairy, Sunnyvale, CA (US); JiHong Min, San Francisco, CA (US); Temitayo Fadelu, Mountain View, CA (US)

(21) Appl. No.: 19/476,064

(22) PCT Filed: Apr. 17, 2024
(86) PCT No.: PCT/US2024/024934

§ 371 Date: Oct. 16, 2025

Related U.S. Application Data
(60) Provisional application No. 63/496,642, filed on Apr. 17, 2023.

(51) Int. Cl. G06F 9/38; G06F 9/48

(52) U.S. Cl. CPC G06F 9/3891; G06F 9/4818

(57) ABSTRACT

Methods and systems, including computer-readable media, are described for implementing a multi-cluster architecture for a hardware machine-learning (ML) accelerator. The architecture is implemented as a hardware integrated circuit and includes a controller that communicates with one or more cores and a first and second cluster of compute tiles. Each of the first and second cluster of compute tiles is configured to execute a respective ML workload. A first workload can be assigned to the first cluster of compute tiles and a second, different workload can be assigned to the second cluster of compute tiles. The first and second workloads are executed concurrently using the first and second clusters based on a program context of at least one core that is coupled to compute tiles of the first and second cluster.

### BACKGROUND

This specification generally relates to a multi-cluster architecture for a hardware machine-learning accelerator.

Machine-learning models can employ neural networks with one or more layers of nodes to generate an output, e.g., a classification, for a received input. Some neural networks include one or more hidden layers in addition to an output layer. Some neural networks can be convolutional neural networks (CNNs) configured for image processing or recurrent neural networks (RNNs) configured for speech and language processing.

Different types of machine-learning architectures can be used to perform a variety of tasks related to classification or pattern recognition, predictions that involve data modeling, and information clustering. A neural network layer can have a corresponding set of parameters or weights. The weights are used to process inputs (e.g., a batch of inputs) through the neural network layer to generate a corresponding output of the layer for computing a neural network inference. A batch of inputs and a set of kernels can be represented as respective tensors, i.e., a first multi-dimensional array of inputs and a second, different multi-dimensional array of weights.

A hardware accelerator is a special-purpose integrated circuit for executing neural networks or other machine-learning models. The integrated circuit can include memory used to store data for multiple tensors. The memory includes individual memory locations that are identified by unique addresses (e.g., virtual or physical addresses). The address locations can correspond to elements of a tensor. Data corresponding to elements of one or more tensors may be traversed or accessed using control logic of the integrated circuit.

### SUMMARY

This document describes techniques for implementing a multi-cluster architecture for a special-purpose hardware integrated circuit, such as a hardware machine-learning (ML) accelerator, tensor processing unit (TPU), or neural network processor. The special-purpose integrated circuit can use the multi-cluster architecture to efficiently execute neural networks and other ML algorithms. The multi-cluster architecture can be implemented in hardware, software, or both.

The multi-cluster architecture includes a controller with one or more cores, a first cluster of compute tiles, and a second cluster of compute tiles. Each of the first and second cluster is configured to independently execute a workload using one or more tiles in its cluster. In some implementations, the first and second cluster can be merged to provide additional processing and computational power, e.g., relating to increased throughput and reduced computing latency. For example, the first and second cluster can be merged using software controls for dynamic cluster configurations.

The multi-cluster architecture leverages control logic and at least one core of the controller to support single and joint program execution modes. For example, in a joint execution mode the first and second clusters cooperate to execute one or more workloads (or programs), whereas in the single execution mode each of the first and second clusters can execute its own respective workload, each of which may be associated with a distinct program. For example, in the joint execution mode, the first and second cluster can be merged to provide additional data processing and compute power for executing one or more workloads. In some implementations, in the single execution mode, the compute operations for the respective workloads are executed in parallel, e.g., concurrently. For example, a first workload assigned to the first cluster and a second workload assigned to the second cluster are executed concurrently based on a program context maintained by at least one core of the controller.

Stated another way, implementations include a joint cluster mode, where at least two clusters are combined as a single (or joint) monolithic cluster. In this mode, an example program or workload now runs on a large monolithic cluster. The implementations also include a multi-program mode, where both clusters are independently running two separate programs/workloads.

One aspect of the subject matter described in this specification can be embodied in an integrated circuit that includes a controller configured to communicate with one or more cores; a first cluster comprising a first multiple of compute tiles, the first cluster being configured to execute a first workload using the first multiple of compute tiles; and a second cluster comprising a second multiple of compute tiles, the second cluster being configured to execute a second workload using the second multiple of compute tiles. The first workload and the second workload are executed concurrently (or sequentially) based on a program context of at least one core that is instantiated by the controller and that is coupled to the first and second multiple of compute tiles.

In some implementations, the controller is configured to execute a single processing instance in which the controller selects between: a single execution mode to concurrently execute the first and second workloads; and a joint execution mode to execute, sequentially or concurrently, the first and second workloads. In some implementations, the controller is further configured to: determine whether the first and second workloads are the same workload; and select the single execution mode to concurrently execute the first and second workloads in response to determining that the first and second workloads are the same workload.

In some implementations, the controller is further configured to: determine whether the first and second workloads are different workloads; and select the joint execution mode to execute, sequentially or concurrently, the first and second workloads in response to determining that the first and second workloads are different workloads. In some implementations, each of the one or more cores is configured to execute multiple program contexts and each program context corresponds to a particular workload.

Each of the one or more cores can be a virtualized scalar core configured for time-multiplexed execution of two or more program contexts; and one or more virtualized scalar cores is assigned to the first cluster or the second cluster. In some implementations, the integrated circuit comprises multiple virtualized scalar cores, wherein each of the multiple virtualized scalar cores is configured to execute a respective program context and is instantiated and managed based on control logic of the controller.

Each virtualized scalar core can be configured to support task preemption, comprising preempting a first task of the first workload to execute a second, different task of the second workload. In some implementations, each virtualized scalar core is configured to: i) execute a low-priority workload comprising a first multiple of tasks; ii) pause executing the low-priority workload at a particular task of the first multiple of tasks; iii) execute a high-priority workload comprising a second multiple of tasks; and iv) after executing the high-priority workload, resume executing the low-priority workload at the particular task of the first multiple of tasks.

In some implementations, the first cluster and the second cluster are homogeneous clusters comprising the same number of compute tiles, whereas in some other implementations, the first cluster and the second cluster are heterogeneous clusters comprising a different number of compute tiles.

One aspect of the subject matter described in this specification can be embodied in a method performed using an integrated circuit comprising a controller, a first cluster comprising a first multiple of compute tiles, and a second cluster comprising a second multiple of compute tiles. The method includes monitoring, by the controller, a single processing instance executed at the integrated circuit using one or more cores that communicate with the controller. The method includes, during the single processing instance: executing, by the first cluster, a first workload using the first multiple of compute tiles; and concurrent with execution of the first workload, executing, by the second cluster, a second workload using the second multiple of compute tiles. The first workload and the second workload are executed concurrently (or sequentially) based on a program context of at least one core that is instantiated by the controller and that is configured to communicate with the first and second multiple of compute tiles.

In some implementations, the method includes, during the single processing instance, selecting, by the controller, between: a single execution mode to concurrently execute the first and second workloads; and a joint execution mode to execute, sequentially or concurrently, the first and second workloads. In some implementations, the method further includes determining, by the controller, whether the first and second workloads are the same workload; and selecting, by the controller, the single execution mode to concurrently execute the first and second workloads in response to determining that the first and second workloads are the same workload.

In some implementations, the method further includes: i) determining, by the controller, whether the first and second workloads are different workloads; and ii) selecting, by the controller, the joint execution mode to execute, sequentially or concurrently, the first and second workloads in response to determining that the first and second workloads are different workloads. Each of the one or more cores can be configured to execute multiple program contexts and each program context can correspond to a particular workload. Each of the one or more cores can be a virtualized scalar core configured for time-multiplexed execution of two or more program contexts; and one or more virtualized scalar cores are assigned to the first cluster or the second cluster.

In some implementations, the method further includes executing, by the controller, executing a respective program context at each virtualized scalar core of multiple virtualized scalar cores, wherein each of the multiple virtualized scalar cores is instantiated and managed based on control logic of the controller. In some implementations, each virtualized scalar core is configured to support task preemption, comprising preempting a first task of the first workload to execute a second, different task of the second workload.

In some implementations, the method further includes: i) executing, by a virtualized scalar core of a cluster, a low-priority workload comprising a first multiple of tasks; ii) pausing, by the virtualized scalar core, executing the low-priority workload at a particular task of the first multiple of tasks; iii) executing, by the virtualized scalar core, a high-priority workload comprising a second multiple of tasks; and iv) after executing the high-priority workload, resuming, by the virtualized scalar core, executing the low-priority workload at the particular task of the first multiple of tasks.

One aspect of the subject matter described in this specification can be embodied in a method performed using a hardware integrated circuit. The method includes: i) generating, by a controller of the integrated circuit, control signals that are used to configure at least a first cluster and a second cluster of the integrated circuit; ii) establishing, at the first cluster, a first program context based on the control signals; and iii) establishing, at the second cluster, a second program context based on the control signals. The method further includes: i) executing, based on the first program context, a first program at the first cluster using compute tiles of the first cluster; and ii) executing, based on the second program context, a second program at the second cluster using compute tiles of the second cluster. The second cluster comprises a different number of compute tiles than the first cluster.

These and other implementations can each optionally include one or more of the following features. For example, in some implementations, establishing the first program context comprises: establishing the first program context using a first scalar core of the first cluster, wherein the first scalar core is configured to maintain one or more hardware states, where each hardware state corresponds to a distinct processing iteration of the first program.

Establishing the second program context comprises: establishing the second program context using a second scalar core of the second cluster, wherein the second scalar core is configured to maintain one or more hardware states. Each hardware state corresponds to a distinct processing iteration of the second program.

In some implementations, the first cluster represents a general-purpose machine-learning hardware accelerator, neural network processor, or tensor processing unit. Relatedly, the second cluster represents a client-specific host processor, such as a machine-learning hardware accelerator, neural network processor, tensor processing unit.

The method further includes: configuring, based on the control signals, the first cluster as a general-purpose tensor processing unit; and configuring, based on the control signals, the second cluster as a client-specific tensor processing unit. The tensor processing unit can represent a hardware integrated circuit such as a ML hardware accelerator or neural network processor configured to implement ML and/or neural network computations.

The control signals can include: configuration control signals that are used to configure the first cluster, a scalar core of the first cluster, the second cluster, and a scalar core of the second cluster; and context control signals that are used to establish the first program context and the second program context.

In some implementations, executing the first program and executing the second program comprises: executing first program and the second program in parallel. Relatedly, the first program and the second program can be different programs. The method further includes: establishing, at a third cluster of the integrated circuit, a third program context based on the control signals; and executing, based on the third program context, a third program at the third cluster using compute tiles of the third cluster.

One aspect of the subject matter described in this specification can be embodied in a system comprising a hardware integrated circuit that includes a processing device and a non-transitory machine-readable storage medium for storing instructions. The instructions are executable by the processing device to cause performance of operations comprising generating, by a controller of the integrated circuit, control signals that are used to configure at least a first cluster and a second cluster of the integrated circuit; establishing, at the first cluster, a first program context based on the control signals; establishing, at the second cluster, a second program context based on the control signals. The operations further comprise executing, based on the first program context, a first program at the first cluster using compute tiles of the first cluster; and executing, based on the second program context, a second program at the second cluster using compute tiles of the second cluster. The second cluster can include a different number of compute tiles than the first cluster.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

The subject matter described in this specification can be implemented in particular embodiments so as to realize one or more of the following advantages.

Unlike conventional accelerator architectures that require a scheduled program be complete before another program may be dispatched, this specification describes a multi-cluster accelerator architecture that provides hardware support for task preemption such that a program running on the accelerator may be preempted to schedule and execute a new program/job.

The disclosed multi-cluster architecture uses localized cores at each tile cluster to manage multiple program contexts at each cluster. The control logic and context protocols of a system controller allows for pausing (or preempting) and dynamic switching between program contexts. A system can leverage this multi-cluster architecture to preserve an execution state of a preempted program context and resume executing the program of that context at a later time period. The task preemption is but one feature of the multi-cluster accelerator architecture that provides for expanded context control and enhanced flexibility for managing concurrent execution of multiple programming contexts in support of ML workloads.

The disclosed techniques provide a hardware architecture that supports accelerated parallel (or concurrent) execution of large ML models, such as large language models and/or large vision/image models, and workloads across multiple tile clusters. The architecture can be used to execute large models and perform inference computations in support of generative artificial intelligence (“GenAI”) uses cases for generating image and text outputs. The multi-cluster accelerator architecture enables spatial partitioning of the accelerator core into smaller accelerator cores such that multiple programs may run in parallel. The techniques provide for a multi-cluster architecture that supports different program execution modes, where the constituent accelerator cores, and tile clusters can be dynamically combined to jointly execute distinct workloads of one or more ML programs.

The multi-cluster architecture can allow for enhanced power management across tile clusters of a hardware integrated circuit. The architecture's controller is configured to execute cluster level power gating that enables improved power efficiency over conventional architectures. For example, a hardware accelerator or special-purpose processor with this multi-cluster architecture can run separate ML inferences on one or more tile cluster(s) and power gate another tile cluster(s) that is not used for the inferences.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example computing system and multi-cluster architecture for a hardware machine-learning accelerator.

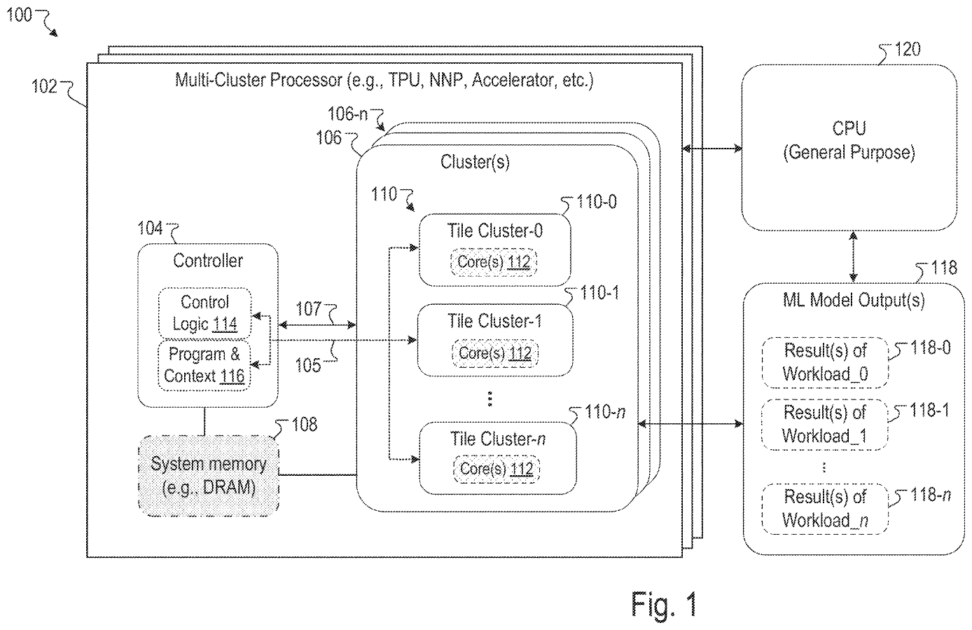

FIG. 2 shows an example computing system with one or more compute tiles for implementing a machine-learning model.

FIG. 3 shows an example scalar core with one or more ports as well as inbound and outbound connections to an example data bus.

FIG. 4 shows an example configuration of the multi-cluster architecture for a single execution mode.

FIG. 5 shows an example configuration of the multi-cluster architecture for a multi-program execution mode.

FIG. 6 shows an example configuration of the multi-cluster architecture for joint/single or multi-program execution modes.

FIG. 7 shows an example of a heterogeneous cluster configuration of the multi-cluster architecture of FIG. 1.

FIG. 8 is an example process for executing machine-learning workloads using the multi-cluster architecture of FIG. 1.

Like reference numbers and designations in the various drawings indicate like elements.

### DETAILED DESCRIPTION

The system 100 includes one or more multi-cluster processors 102, a controller 104, one or more clusters 106, and a system memory 108. In some implementations, system 100 is a system-on-chip (SoC) of a consumer electronic/mobile device, such as a smartphone, smart speaker, tablet, or laptop. The multi-cluster processor 102 can be configured as an instruction and vector data processing engine that processes data obtained from a system memory 108, such as a dynamic random access memory (DRAM) of the SoC.

In some implementations, the system 100 includes multiple controllers 104 and/or multiple clusters 106 (e.g., groups/blocks of clusters 106-n), whereas in some other implementations, the system 100 includes a single controller 104 for a single cluster 106.

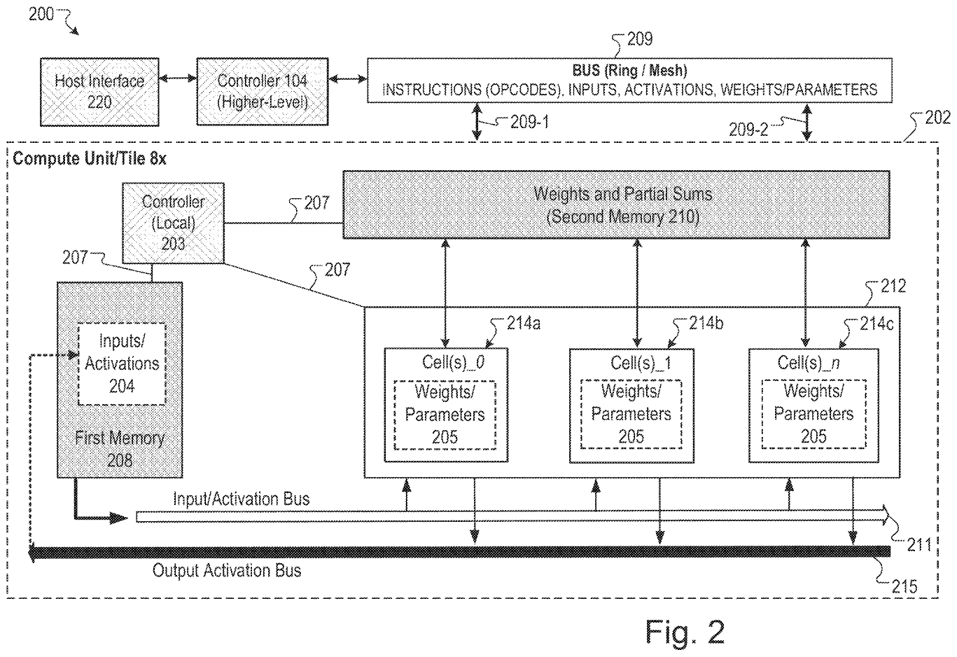

The controller 104 includes control logic 114 (“logic 114”) and program & context logic 116 (“logic 116”). The cluster 106 includes one or more tile clusters 110 and each tile cluster includes one or more compute tiles and at least one core 112 for the one or more compute tiles. An example compute tile is described below with reference to FIG. 2.

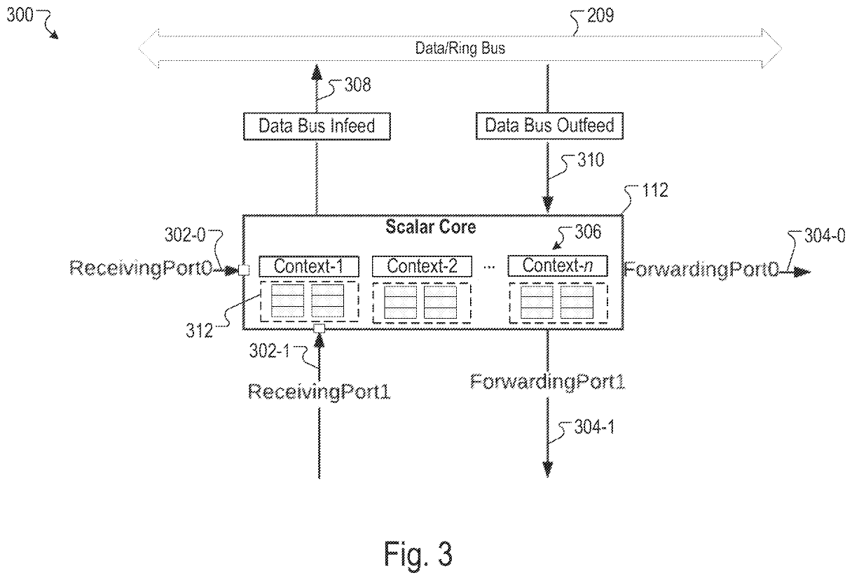

More specifically, a cluster 106 includes n tile clusters 110-n and each tile cluster 110-n includes n compute tiles, where n is an integer greater than one. Relatedly, each tile cluster 110-n can include a single core 112 or, alternatively, multiple cores 112. Each core 112 of system 100 is an example processing device that manages or otherwise controls program tasks and compute operations for a cluster of compute tiles. In some implementations, the cores 112 are implemented as a scalar core or virtualized scalar core (described below). An example core (e.g., a scalar core) is described below with reference to FIG. 3.

The controller 104 exchanges various types of signals communications with at least the cluster 106 of system 100. For example, a first type of signal communication 105 can include control signals associated with logic 114 and program or context signals associated with logic 116. A second type of signal communication 107 can be control (or configuration) signals for establishing or configuring a structure of a tile cluster 110. Other types of signal communications 105, 107, such as signals for direct memory access operations at the compute tiles and routing inputs/operands to the compute tiles, are also within the scope of this disclosure.

A configuration of cores 112 and compute tiles for a particular tile cluster 110 can be static for a given design or iteration of the system 100. Alternatively, the controller 104 can include a dynamic configuration option, where the controller 104 uses the signal communications 107 to set a configuration of cores 112 and compute tiles for a particular tile cluster 110. The controller 104 can generate configuration control signals to configure one or more cores and to configure a specific quantity of compute tiles at each tile cluster 110. For example, a signal communication 107 can include configuration control signals that are used to: i) configure a first core and configure a first quantity of compute tiles at tile cluster 110-0 and ii) configure a second core and configure a second quantity of tiles at tile cluster 110-1.

In some implementations, the first quantity of compute tiles at tile cluster 110-0 and the second quantity of compute tiles at tile cluster 110-1 are the same, whereas in some other implementations the first quantity of compute tiles at tile cluster 110-0 and the second quantity of compute tiles at tile cluster 110-1 are different. Each tile cluster 110-n is configured to execute a workload using the one or more compute tiles at that tile cluster. For example, tile cluster 110-0 can execute a first workload_0 and tile cluster 110-1 can execute a second workload_1.

The controller 104 can be used to perform one or more methods and processes for executing workloads and programs at the system 100. The method includes: i) generating, by controller 104, control signals that are used to configure at least a first cluster 110-0 and a second cluster 110-1 of the integrated circuit; ii) establishing, at the first cluster 110-0, a first program context based on the control signals; and iii) establishing, at the second cluster 110-1, a second program context based on the control signals. The method further includes: i) executing, based on the first program context, a first program at the first cluster 110-0 using compute tiles of the first cluster; and ii) executing, based on the second program context, a second program at the second cluster 110-1 using compute tiles of the second cluster. The second cluster comprises a different number of compute tiles than the first cluster.

Each tile cluster 110 is configured to generate one or more outputs 118 for a given workload in response to executing for the workload. The outputs 118 can include a respective result, or a respective set of results, for each workload. For example, an output 118 can include a result 118-0 for the first workload_0 and a result 118-1 for the second workload_1. In general, the workloads are ML workloads processed by, for example, a ML model(s) executed by the cluster 106. In some cases, the workloads are general-purpose data processing workloads.

In some implementations, the ML model is an artificial neural network with one or more neural network layers and an output 118 (or result 118-n) generated by a tile cluster 110-n corresponds to a layer output for a layer of the neural network. In some implementations, the ML model is configured for image processing and an output 118 (or result 118-n) generated by a tile cluster 110-n corresponds to an image processing output.

For example, the system 100 can be installed in a self-driving vehicle and used to process images in support of autonomous operation of the vehicle.

The system 100 includes a central processing unit (CPU) 120, such as a general purpose CPU, a multi-core CPU, or a combination of these. In some implementations, the CPU 120 is an example processor engine with multiple (e.g., more than two) processor cores. For example, the CPU 120 can include a first processor engine/core and a second, different processor engine/core. In some implementations, the first processor engine and the second processor engine are distinct processors. In some other implementations, the first and second processor engines are distinct cores of a single processor.

The CPU 120 manages data stored at the memory 108 and issues instructions for triggering execution of one or more workloads at tile clusters 110 of the cluster 106. CPU 120 can issue instructions to trigger one or more workloads for image processing inferences to occur at the cluster 106. In some implementations, the controller 104, including its control logic 114 and program & context logic 116, is an extension of the CPU 120. The CPU 120 can use the controller 104 to apply ML algorithms to process audio, image, or other data captured or received at a user device that includes the disclosed multi-cluster architecture.

For example, the CPU 120 can determine or detect that a new image was captured based on a control signal generated by a camera application of a user device. Pixel data for the image may be stored at memory 108 and the CPU 120 can issue an instruction to controller 104 to initiate an inference workload against the image. The inference workload can be executed by processing the pixel data at the cluster 106 using one or more tile clusters 110.

The CPU 120 and/or controller 104 can issue various instructions to: i) pass/route the pixel data from memory 108 to one or more tile clusters 110, ii) configure one or more scalar cores 112 to execute a respective portion of the inference workload, and iii) instantiate or establish program contexts at the one or more scalar cores 112 to execute the inference workloads. In some implementations, the pixel data is passed to a tile cluster 110 as a multiple dimensional input tensor and various dimensions of the input tensor may be allocated to a particular compute tile 202 of a tile cluster 110.

FIG. 2 is a block diagram of an example computing system 200 for implementing a ML or neural network model at a hardware integrated circuit, such as a ML hardware accelerator. In general, computing system 200 is included in computing system 100, for example, as a sub-system of computing system 100. Computing system 200 includes one or more compute tiles 202, a host interface 220, and a higher-level controller (e.g., controller 104). As described in more detail below, the host interface 220 and controller 104 cooperate to provide datasets and instructions to one or more compute tiles 202 of system 200.

In some implementations, the host interface 220 and the controller 104 are distinct devices, whereas in some other implementations the host interface 220 and the controller 104 are the same device. The host interface 220 and the controller 104 can also perform distinct functions but be integrated in a single device package. For example, the host interface 220, controller 104, and multiple compute tiles 202 are included or formed as different sections on a single integrated circuit die for a hardware accelerator.

The host 220 and controller 104 interacts or cooperates with CPU 120 to execute and/or accelerate computations for various data, video, and/or graphics processing applications. In some implementations, the host 220, controller 104, and multiple compute tiles 202 form a special-purpose System-on-Chip (SoC) that is optimized for executing processing ML models and workloads, including neural network models for image processing applications.

Each compute tile 202 generally includes a controller 203 that provides one or more control signals 207 to cause inputs or activations for a vector of inputs 204 (“input vector 204”) to be stored at, or accessed from, a memory location of a first memory 208 (“memory 208”). Likewise, the controller 203 can also provide one or more control signals 207 to cause weights (or parameters) for a matrix structure of weights 205 to be stored at, or accessed from, a memory location of a second memory 210 (“memory 210”). In some implementations, the vector of inputs 204 is obtained from an input tensor, whereas the matrix structure of weights is obtained from a parameter tensor. Each of the input tensor and the parameter tensor may be multi-dimensional data structures, such as a multi-dimensional matrix or tensor.

Memory 208 and memory 210 are portions of tile memory. Each memory location of memory 208, 210 may be identified by a corresponding memory address, such as a logical address that has a corresponding mapping to a physical row of a physical memory bank of the memory. Thus, much like the processor engine 102, a compute tile 202 may also derive a set of contiguous addresses, such as virtual/logical addresses or physical addresses, from a group of requests.

Each of memory 208, 210 can be implemented as a series of physical banks, units, or any other related storage medium or device. Each of memory 208, 210 can include one or more registers, buffers, or both. In some implementations, each bank of a compute tile 202 includes an arbiter that arbitrates access to that bank. For example, access to the bank can be arbitrated in accordance with a bank generation function configured to mitigate against some (or all) of the requests being routed to the same physical memory bank.

In some implementations, memory 208 is an input/activation memory, whereas memory 210 is a parameter memory. In some other implementations, inputs or activations are stored at memory 208, memory 210, or both; and weights are stored at memory 210, memory 208, or both. For example, inputs and weights may be transferred between memory 208 and memory 210 to facilitate certain neural network computations. In some implementations, each of memory 208 and memory 210 may be referred to as tile memory.

Each compute tile 202 also includes an input activation bus 211, an output activation bus 215, and a computational unit 212 that includes one or more hardware multiply accumulate circuits (MACs) in each cell 214 a/b/c. Controller 203 can generate control signals 207 to obtain operands stored at the memory of the compute tile 202. For example, controller 203 can generate control signals 207 to obtain: i) an example input vector 204 stored at memory 208 and ii) weights 205 stored at memory 210. Each input obtained from memory 208 is provided to input activation bus 211 for routing (e.g., direct routing) to a compute cell 214 a/b/c in the computational unit 212. Similarly, each weight obtained from memory 210 is routed to a cell 214 a/b/c of the computational unit 212.

As described below, each cell 214 a/b/c performs computations that produce partial sums or accumulated values for generating outputs for a given neural network layer. An activation function may be applied to a set of outputs to generate a set of output activations for the neural network layer. In some implementations, the outputs or output activations are routed for storage and/or transfer via output activation bus 215. For example, a set of output activations can be transferred from a first compute tile 202 to a second, different compute tile 202 for processing at the second compute tile 202 as input activations for a different layer of the neural network.

In general, each compute tile 202 and system 200 can include additional hardware structures to perform computations associated with multi-dimensional data structures such as tensors, matrices and/or data arrays. In some implementations, inputs for an input vector (or tensor) 204 and weights 205 for a parameter tensor can be pre-loaded into memory 208, 210 of the compute tile 202. The inputs and weights are received as sets of data values that arrive at a particular compute tile 202 from a host 220 (e.g., an external host), via a host interface, or from a higher-level control such as controller 104.

Each of compute tile 202 and controller 203 can include one or more processors, processing devices, and various types of memory. In some implementations, processors of compute tile 202 and controller 203 include one or more devices, such as microprocessors or central processing units (CPUs), graphics processing units (GPUs), application specific integrated circuits (ASICs), or a combination of different processors. Each of compute tile 202 and controller 203 can also include other computing and storage resources, such as buffers, registers, control circuitry, etc. These resources cooperate to provide additional processing options for performing one or more of the determinations and calculations described in this specification.

In some implementations, the processing unit(s) of controller 203 executes programmed instructions stored in memory to cause controller 203 and compute tile 202 to perform one or more functions described in this specification. The memory of controller 203 can include one or more non-transitory machine-readable storage mediums. The non-transitory machine-readable storage medium can include solid-state memory, a random access memory (RAM), a read-only memory (ROM), an erasable programmable read-only memory (e.g., EPROM, EEPROM, or Flash memory), or any other tangible medium capable of storing information or instructions.

The system 200 receives instructions that define a particular compute operation to be performed by a compute tile 202. The system 200 also receives data such as inputs, activations, weights (or parameters) that are operands for the compute operation. The system 200 can include one or more buses 209 that are used for routing the instructions and data. For example, the system 200 can include a first bus 209-1 that provides instructions, including related commands, opcodes, and operational parameters (not weights), to each of the one or more compute tiles 202 of the system 200. The system 200 can also include a second bus 209-2 that provides data or operands to each of the one or more compute tiles 202 of the system 200.

The buses 209 can be configured to provide one or more interconnected data communication paths between two or more compute tiles of system 200. For example, the first bus 209-1 can be a ring bus that traverses each compute tile to communicate datasets and a single instruction (or multiple instructions) to one or more compute tiles to execute an ML workload, whereas the second bus 209-2 can be a mesh bus that interconnects two or more tiles to provide data or sets of operands between two or more compute tiles 202.

In some implementations, bus 209-1 and bus 209-2 are distinct data buses. In some other implementations, bus 209-1 and bus 209-2 are the same data bus. To process an example workload, a first compute tile 202 can arbitrate and execute access requests (e.g., read/write requests) for memory 208. The requests can be based on external data communications that originate from outside the first compute tile 202, such as from a second, different compute tile 202. Such external communications may be received at the first tile 202 via bus 209-2 (e.g., a mesh bus).

Each compute tile 202 is an individual computing unit that cooperates with other tiles 202 in the system 200 to accelerate computations across one or more layers of a multi-layer neural network or across one or more sections of another ML construct. Each compute tile 202 can function as an individual computing unit. For example, each compute tile 202 is a self-contained computational component that is configured to execute a subset of tensor or ML computations independently relative to other compute tiles. In some implementations, compute tiles 202 can also share execution of tensor computations associated with a given instruction.

In some implementations, a host can generate sets of parameters (i.e., weights) and corresponding inputs for processing at a neural network layer. The host can send, via a host interface 220, the parameters to a compute tile 202 for further processing at the tile. In some implementations, the host is processor engine 102 or a respective core or processor of processor engine 102. The controller 203 executes programmed instructions to analyze a data stream associated with the received weights and inputs.

The controller 203 causes inputs and weights of the data stream to be stored at the compute tile 202. For example, the controller 203 can store the inputs and weights/parameters in the local tile memory of the compute tile 202. The controller 203 can also analyze the input data stream to detect an operation code (“opcode”). The system 200 can support various types of opcodes, such as opcode types that indicate operations for vector-matrix multiplication and/or element-wise vector operation.

Based on one or more opcodes, the controller 203 can activate or execute a bank generation function to arbitrate requests for access to tile memory of a compute tile 202. For example, the controller 203 leverages the bank generation function to arbitrate two or more requests such that each of the two or more requests are processed against different physical banks of the tile memory. The controller 203 can employ a predetermined bank selection scheme that is programmed or encoded at the controller 203 before inference determinations are performed at the compute tile 202.

In some implementations, a given compute operation involves multiple requesters that each require access to resources of the memory 208. For example, a computational workload performed at compute tile 202 can trigger memory access requests due to tensor traversal operations that require read and write access to respective address locations of memory 208. The system 200 can use byte-level addressing functions of an example instruction set architecture (ISA) to process these requests to access one or more bytes of data stored at address locations of memory 208, 210. As described below, these address locations can correspond to elements of an input (or parameter/weight) tensor that is processed to execute a ML workload.

In addition to the tensor read/write operations, processing the workload can also involve processing read or write access requests to: i) move data (e.g., parameters) from memory 208 (narrow memory) to memory 210 (wide) and ii) move data from memory 210 (wide) to memory 208 (narrow). Tensor operations (TensorOps) can be indicated by an opcode in an instruction (e.g., a single instruction) received at a compute tile 202. For example, a “ByteAddressingMode” instruction can include one or more opcodes for a tensor operation that is executed at the compute tile 202 to traverse respective elements of an input tensor. In general, tensor operations can be performed to: i) consume (or read) tensors from memory 208, 210 and ii) produce (or write) tensors to memory 208, 210.

As used in this document, “narrow” may refer to one or more memory units that each operate on, and store, data having a size (or width) that is equal to or less than 16-bits, whereas “wide” may refer to one or more memory units that each operate on, and store, data having a size (or width) that is equal to or less than 64-bits. For example, a size or width for narrow memory 208 can between 8-bits and 16-bits, whereas a size or width for wide memory 210 can between 32-bits and 64-bits. Of course, other sizes and data widths that exceed these example ranges are also contemplated for memory 208, 210.

FIG. 3 shows an example core 112 with one or more ports as well as inbound and outbound connections to an example data bus 209.

Core 112 includes receiving ports 302-0 and 302-1 and forwarding ports 304-0 and 304-1. Core 112 also includes a bus infeed connection 308 and a bus outfeed connection 310. The bus infeed connection 308 is configured to route data from the data bus 209 of the system 100 to a scalar core 112 of a tile cluster 110, whereas the bus outfeed connection 310 is configured to route data from a tile cluster 110 to the data bus.

More specifically, data is received at a scalar core 112 via the receiving ports 302-0, 302-1 and bus outfeed connection 310, whereas data can be provided by/from the scalar core 112 via the forwarding ports 304-0, 304-1 and bus infeed connection 308. Data communications are exchanged between scalar cores 112 via the receiving ports 302-0, 302-1 and forwarding ports 304-0, 304-1. In some implementations, data may be received at a scalar core 112 via the receiving ports 302-0, 302-1 and sent out to the data bus 209 via the bus infeed connection 308. Relatedly, data may be received at the scalar core 112 via the bus outfeed connection 310 and forwarded to another scalar core 112 via the forwarding ports 304-0, 304-1.

The scalar core 112 is configured to send data to the bus infeed connection 308 by popping inputs and parameters that are stored in hardware the scalar core 112. In this example, inputs and parameters relate to a neural network layer of an artificial neural network implemented at the integrated hardware circuit. More specifically, the parameters can be a set of weights for a neural network layer, whereas the inputs can be layer inputs or activations for processing through the neural network layer in accordance with the set of weights for the layer. In some implementations, a scalar core 112 receives data representing inputs/activations and parameters via the receiving ports 302-0, 302-1 and then sends (or pops) that data out to the data bus 209 via the bus infeed connection 308.

In some implementations, the core 112 is a “Scalar core,” as indicated in the example of FIG. 3. Each of the one or more scalar cores 112 of system 100 is configured to maintain multiple program contexts 306. In general, a “scalar core” is a context manager that controls and dispatches jobs, including tasks associated with a program or workload. As used in this specification, a context (or program/ming context) can be an execution state or processing iteration for a given task, program, workload, or inference job. The execution state can include all relevant information and/or objects needed to complete the task, where the relevant information can include data such as inputs, operands, instructions, function calls, etc. The context can include a series of program (or hardware) states, including interrupts or branch conditions, in which the relevant information is processed to accomplish a particular goal, such as generating an inference output.

Each program context 306 can correspond to a particular workload, including a particular task or subset of tasks of a workload. So, in contrast to conventional architectures that support only a single program context, each scalar core 112 is configured to support multiple program contexts corresponding to multiple ML workloads. The system 100 can use data bus 209 to convey program data and/or relevant context information between two or more scalar cores 112. In these examples, the data bus can be configured as a ring bus that interconnects two or more tile clusters 110 and interconnects a respective scalar core 112 in each tile cluster 110.

The scalar core 112 is configured to provide temporal concurrency to an example TPU, accelerator, or neural net processor that includes the multi-cluster architecture disclosed in this document. To provide temporal concurrency, the multi-cluster architecture and scalar cores 112 are configured to provide hardware (and/or software) support for workload/task preemption. Each scalar core 112 allows for preempting a current workload (or task of a workload), installing a new workload or task, switching to another on-going workload, or a combination of theses.

More specifically, each of the one or more scalar cores 112 is a virtualized scalar core 112 configured for time-multiplexed execution of two or more program contexts, including preserving an execution state of an existing program context. The “virtualized” aspect or attribute of a scalar core 112 refers to the multi-context features of the core, including the control logic and hardware features that enable the scalar core to maintain multiple program states. Each scalar core 112 includes physical hardware features 312, such as physical ports/slots, buffers, program counters, registers, etc., that facilitate and/or enable the preemption features and time-multiplexed execution of multiple program contexts.

In some implementations, a scalar core 112 can include multiple physical slots/ports (e.g., receiving ports 302-0, 302-1) for receiving data representing multiple workloads (or jobs). The scalar core 112 can leverage its hardware features 312 to implement context switching in an efficient manner. More specifically, when preempting an existing workload (“Job A”) to run a new workload (“Job B”), rather than flushing or deleting hardware states associated with Job A, the scalar core 112 uses its hardware features to store a current hardware state of the existing workload, Job A.

The virtualized aspect of the scalar core 112 also implies that two or more contexts that are preserved in hardware are also securely isolated for a given software layer of each context. In some implementations, a context includes a software layer and a corresponding hardware state that is preserved for that context. The hardware state is securely isolated and linked to that software layer, such that this isolated hardware state cannot be used for another context or software layer.

£ So, rather than flushing, restarting, and reloading a hardware state for Job A, the scalar core 112 can simply pause Job A, store a streamlined set of values to capture the hardware state of Job A, and then switch to Job B. In some implementations, a workload/job may be paused in response to the unexpected arrival/scheduling of a higher priority workload/job or the arrival of a higher priority task of a higher priority workload/job.

Leveraging the hardware features 312 to capture and preserve hardware states in this manner minimizes workload transition latency, switching overhead, and resource consumption at the scalar core 112. For example, Job A can be a facial recognition workload related to device security, whereas Job B can be an image post-processing workload for the camera application. The scalar core 112 can execute and manage both jobs at a single tile cluster 110. In particular, the scalar core 112 can quickly transition or switch between Job A and Job B with low latency such that the transition between facial recognition and image processing via the camera appears snappy and responsive to the user.

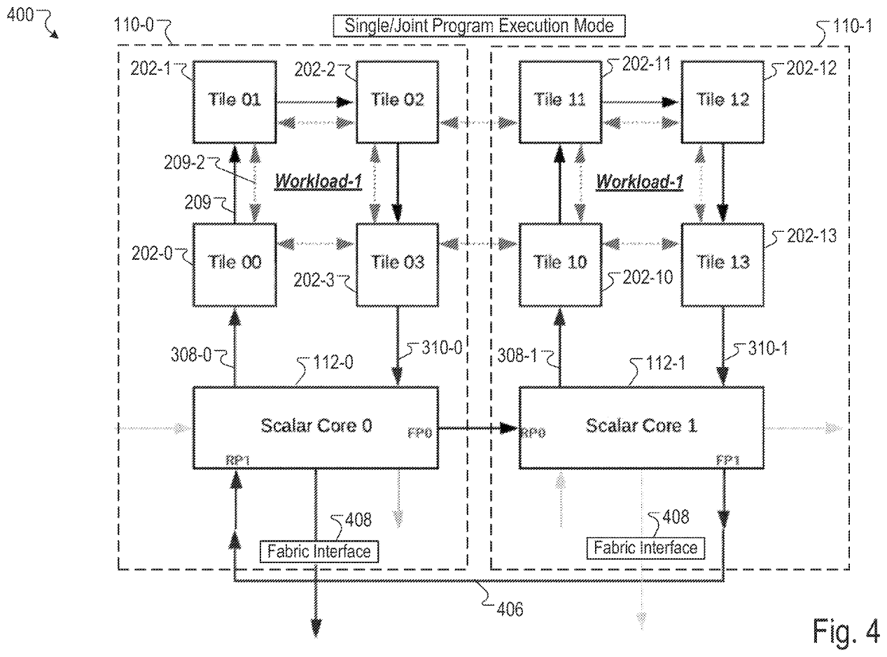

FIG. 4 shows an example configuration 400 of the multi-cluster architecture for a single execution mode or, alternatively, a joint/single execution mode. For clarity, a single execution mode is when a single tile cluster 110 executes or works on a single workload (e.g., “Workload-1”), whereas a joint/single execution mode is when two or more tile clusters 110 cooperate to execute a single workload.

The cluster 106 can include multiple scalar cores 112. For each scalar core 112, program contexts and corresponding workloads/jobs can be instantiated and managed based on control logic of the controller 104. For example, a program context for Workload-1 can be instantiated, controlled, or otherwise managed by one or more scalar cores 112 based on configuration and control signals of signal communications 107 exchanged between the controller 104 and the cluster 106.

In a single execution mode, the controller 104 can instantiate a program context for Workload-1 and use scalar core 112-0 (or 112-1) to the manage the instructions, data, tasks, and computations required to execute Workload-1 at the tile cluster 110-0 (or 110-1). Thus, in this single execution mode, to execute Workload-1, the controller 104 can use either: i) tile cluster 110-0 and scalar core 112-0 or ii) tile cluster 110-1 and scalar core 112-1.

Relatedly, in a joint/single execution mode, scalar core 112-0 and scalar core 112-1 work together to execute Workload-1. More specifically, the controller 104 uses scalar cores 112-0 and 112-1 to instantiate and share executing the program context(s) for Workload-1. The controller 104 then uses scalar cores 112-0 and 112-1 to manage the instructions, data, tasks, and computations to execute Workload-1 at tile cluster 110-0 and tile cluster 110-1.

As illustrated in the example of FIG. 4, the compute tiles 202 of a tile cluster 110 can be arranged in a ring configuration and the bus 209 is configured as a ring bus such that a data path associated with the ring bus traverses each of the compute tiles 202 in a tile cluster 110. In this implementation, the system 100 can send (and receive) signal communications 105, 107 to some (or all) of the scalar cores 112 at each tile cluster 110 over the ring bus 109. In some implementations, the data path of bus 209 is non-blocking, which means that a request can continue traversing the ring bus 209 from a first compute tile 202 to a next/second compute tile 202 without waiting for a response from a previous tile.

The system 100 includes an example instruction set that is implemented as firmware. For example, the firmware can represent the logic 114, 116 of controller 104, can be included among logic 114, 116 of the controller 104, or both. The firmware of the system 100 is operable to manage multiple program contexts in each of the different tile clusters 110. In some implementations, each tile cluster 110 exposes an independent instruction queue to the firmware which is used to manage one or more program contexts of the tile cluster 110.

For example, the tile cluster 110 can expose the instruction queue by way of a respective scalar core 112 that is assigned to the tile cluster 110.

The bus 209 can be configured as an instruction and vector data bus for routing instructions and/or data to each tile cluster 110. The data traffic can be routed and/or managed at bus 109 based on an on-chip communication bus protocol, such as the Advanced extensible Interface (AXI) protocol or other related bus protocols. In some implementations, the bus 209 is included as part of a fabric interface 408 of the system 100, where the fabric interface 408 is used to route data traffic, such as requests involving tensor data stored at tile memory of compute tiles in a tile cluster 110. For example, the requests can be read/load (LD) requests to obtain tensor data from the tile memory and write/store (ST) requests to provide tensor data to tile memory.

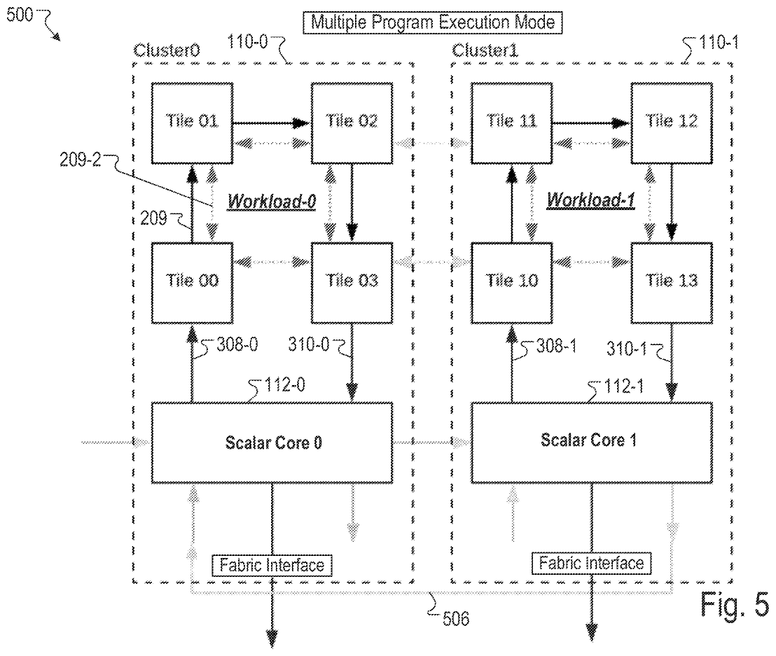

FIG. 5 shows an example configuration 500 of the multi-cluster architecture for a multi-program execution mode. For clarity, a multi-program (or multiple program) execution mode is when two or more tile clusters 110-n execute a respective workload.

The respective workloads can be distinct workloads and the two or more tile clusters 110-n can concurrently execute their respective workload. The controller 104 can use logic 114, 116 to initiate or transition to a multi-program execution mode where a group of compute tiles 202 (e.g., a tile cluster 110) contemporaneously execute multiple distinct workloads. In some implementations, each respective workload is a constituent workload (e.g., sub-workloads) of a larger workload or large ML model. In some implementations, some (or all) of the architectures described in this specification are used to execute large models and perform inference computations in support of generative artificial intelligence (“GenAI”) uses cases for generating image and text outputs.

In the example of FIG. 5, based on the multi-cluster architecture disclosed in this document, tile cluster 110-0 executes or works on a first workload (e.g., “Workload-0”), whereas tile cluster 110-1 executes or works on a second workload (e.g., “Workload-1”).

The controller 104 is configured to orchestrate or manage switching operations for transitioning (or switching) between execution modes at one or more clusters 106/106-n. For example, the controller 104 can use logic 114, 116 to configure and control dynamic or iterative switching between joint/single program modes and multi-program modes of the multi-cluster processor 102. In some implementations, system 100 is able to configure or reconfigure interactions between the scalar cores 112 to operate in a joint/single program mode or multi-program mode.

In some implementations, during the single program mode: two workloads can run in parallel, whereas, during the joint program mode: two workloads can run back-to-back, without invoking preemption support. In this joint program modes, two or more clusters can be configured to as a large joint cluster that provides more compute power.

The controller 104 is configured to execute one or more processing instances. In some implementations, the controller 104 executes a processing instance (e.g., a single instance) in which the controller 104 selects between: i) a single execution mode to execute the first and/or second workloads; ii) a joint/single execution mode to concurrently execute the first and second workloads, where tile clusters 110-n jointly work on a single program/ML workload; and iii) multi-program execution mode to concurrently execute the first and second workloads, where tile clusters 110-n jointly work on multiple programs/ML workloads.

In some implementations, the controller 104 selects a particular execution mode based on instructions issued by the CPU 120 or workload attributes specified in a request to execute a particular program. The controller 104 can determine whether the first and second workloads are the same workload (or same workload type) or associated with the same program. For example, the controller 104 can determine that Workload-0 and Workload-1 are for the same image (or speech) processing request/program and select the joint execution mode to concurrently execute Workload-0 and Workload-1. In this mode, tile clusters 110-0, 110-1 jointly work on Workload-0 and Workload-1 in parallel, e.g., as a monolithic cluster, to generate an image processing output.

Relatedly, the controller 104 can determine whether the first and second workloads are different workloads, or different workload types. The controller 104 may also determine that the first and second workloads are not associated with the same program. For example, the controller 104 can determine that Workload-0 and Workload-1 are for different image (or speech) processing requests/programs and select the multi-execution mode to concurrently execute the first and second workloads. In this mode, tile clusters 110-0, 110-1 can concurrently work on Workload-0 and Workload-1 as distinct image and/or speech processing programs to generate a corresponding output.

In the example of FIG. 5 the first tile cluster 110-0 and the second tile cluster 110-1 are homogeneous tile clusters that include the same number of compute tiles 202. However, as described below, two or more tile clusters 110-n can also include a different number of compute tiles 202.

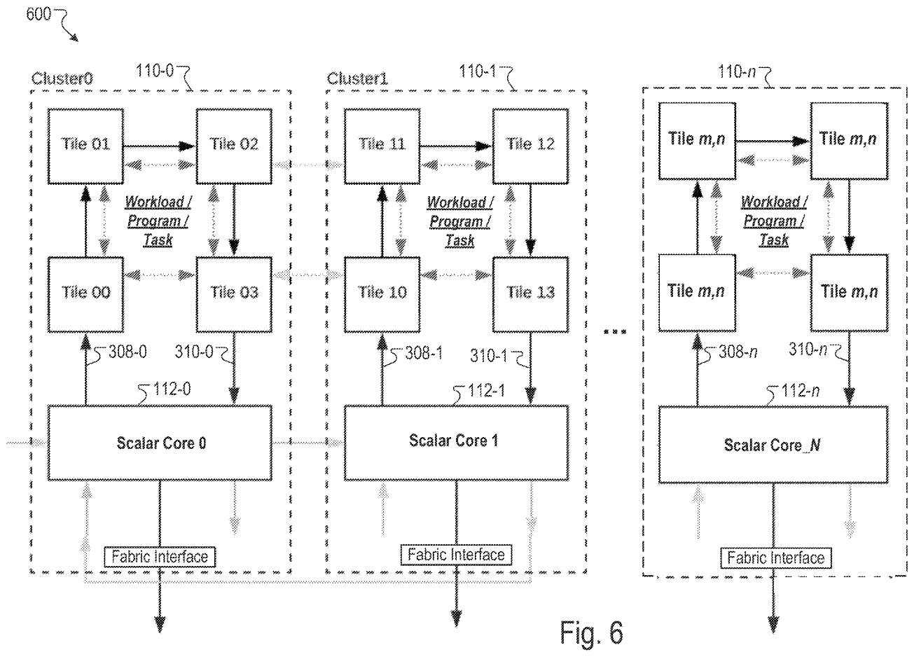

FIG. 6 shows an example configuration 600 of the multi-cluster architecture for single, joint, or multi-program execution modes.

As described above, the multi-cluster processor 102 can include one or more clusters 106, including multiple tile clusters 110-n and multiple virtualized scalar cores 112-n per cluster, where at least one virtualized scalar core 112 is included at each tile cluster 110-n. The multi-cluster architecture of processor 102 uses the localized scalar cores 112-n at a corresponding tile cluster 110-n to manage multiple program contexts at the tile cluster 110. For each virtualized scalar core 112-n, program contexts and corresponding workloads/jobs can be instantiated and managed/controlled based on logic 114, 116 and signal communications 105, 107 of controller 104.

Using logic 114, 116, the controller 104 can generate control signals for controlling different scalar cores 112 and configuration signals for configuring different programs/workloads and program contexts at a particular tile cluster 110. The controller 104 can pass these signals to the tile clusters 110-n using the signal communications 105, 107. Each virtualized scalar core 112 of the multi-cluster processor 102 is configured to support task preemption. More specifically, each virtualized scalar core 112 is configured for time-multiplexed execution of two or more program contexts, including preserving an execution state of an existing program context.

For example, this time-multiplexed execution and task preemption can include preempting a first workload (e.g., Workload-0) to execute a second, different workload (e.g., Workload-1). Further, the task preemption can include preempting (or pausing) a first task of the Workload-0 to execute a second, different task of Workload-1. Further still, the time-multiplexed execution and task preemption can include the multi-cluster processor 102: i) preempting an existing program being executed using a first program execution mode, ii) reconfiguring one or more virtualized scalar cores 112 to operate in a second, different program execution mode, and iii) executing a new program executed using the second, different program execution mode.

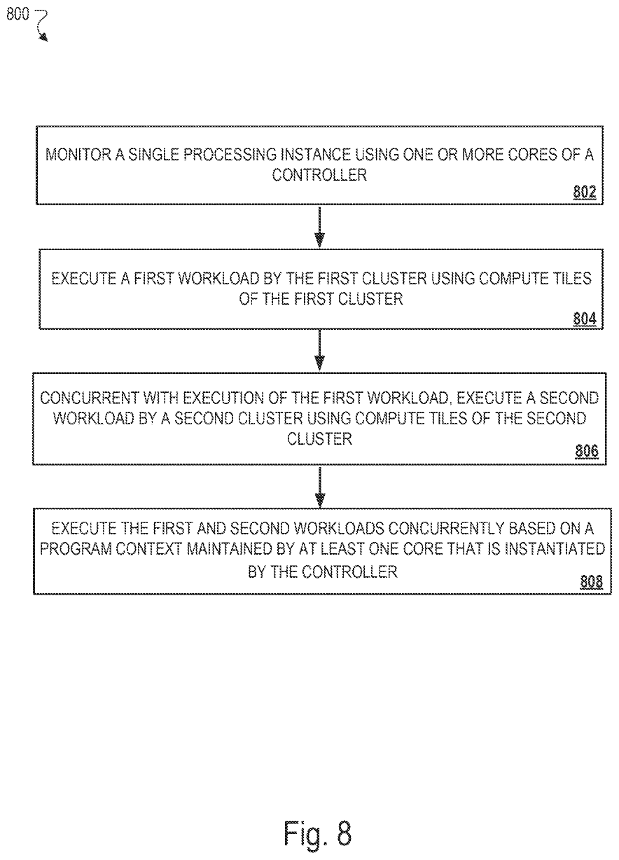

Thus, in some implementations, the concurrent execution of two or more workloads (e.g., Workload-0 and Workload-1) is initiated or preceded by preempting an existing workload(s), where the existing workload(s) is performed using a different program execution mode (e.g., multi-program execution mode). This is described below with reference to the example of FIG. 8.

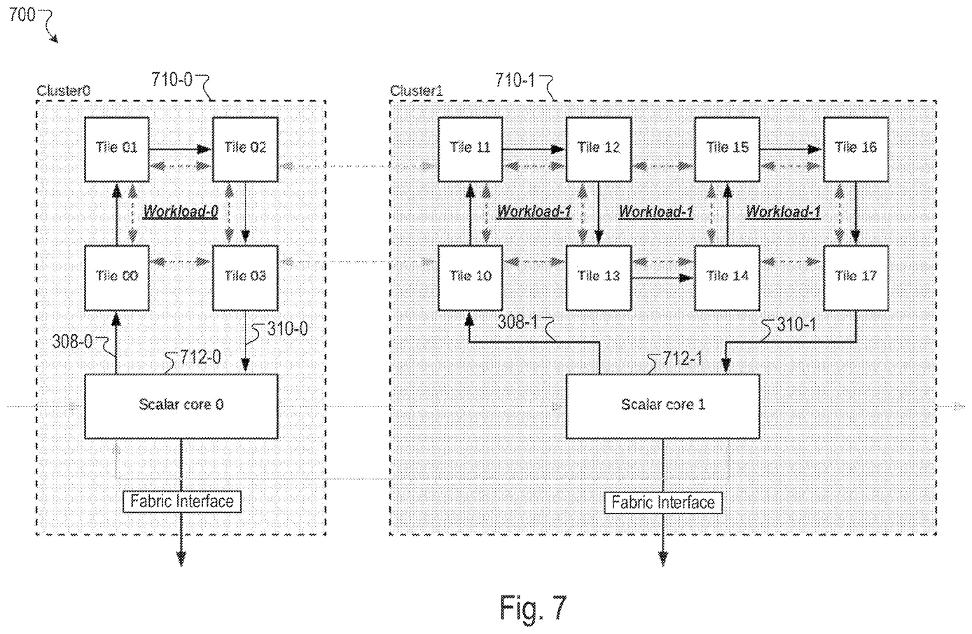

FIG. 7 shows an example of a heterogeneous cluster configuration of the multi-cluster architecture.

More specifically, in the example of FIG. 7 the first tile cluster 110-0 and the second cluster 110-1 are heterogeneous tile clusters that include a different number of compute tiles 202. Stated another way, based on this multi-cluster architecture, the compute tiles 202 of an example ML hardware accelerator are assigned/partitioned into heterogeneous clusters, where a different number of compute tiles 202 are included in two different clusters, such as first tile cluster 710-0 and second tile cluster 710-1.

Each of tile clusters 710-0, 710-1 has a virtualized scalar core 712-0, 712-1 and can be assigned different programs that are managed and controlled by its respective virtualized scalar core. For example, as opposed to a single program mode, a camera program can be run on a tile cluster 710-0, whereas a general-purpose program(s) can be run on tile cluster 710-1. In some implementations, tile cluster 710-0 and tile cluster 710-1 are respective instantiations of two distinct TPUs, e.g., TPU-A and TPU-B. For example, tile cluster 710-0 (TPU-A) can be configured as a workload/client-specific TPU, whereas tile cluster 710-1 (TPU-B) can be configured as a general-purpose TPU. The TPU-A/B can be described alternatively as a host processor, ML hardware accelerator, or neural network processor.

In some implementations, each compute tile 202 in a tile cluster 110 is identically configured. In some other implementations, two or more compute tiles 202 in a tile cluster 110 may be configured differently. For example, one compute tile 202 can have more or fewer multiply accumulate circuits/cells (MACs) relative to another compute tile 202. As another example, one compute tile can have more or fewer tile memory resources relative to another compute tile 202. As yet another example, one compute tile 202 can have a different data path configuration between its memory resources and its computational unit 212 relative to another compute tile 202.

The disclosed multi-cluster architecture allows for enhanced power management across tile clusters of a hardware integrated circuit. In some implementations, tile cluster 710-0 (or 110-0) and tile cluster 710-1 (or 710-1) can be dynamically power gated based on logic 114, 116 of controller 104. For example, controller 104 is configured to execute cluster level power gating to minimize power consumption if a particular tile cluster is not used or required for a particular workload or group of workloads. For example, multi-cluster processor 102 can run separate ML inferences on one or more tile cluster(s) and power gate another tile cluster(s) that is not used for the inferences.

FIG. 8 is an example process 800 for executing ML workloads using one or more configurations of the multi-cluster architecture described above.

In general, process 800 can be implemented or executed using the systems 100, 200 described above. Hence, descriptions of process 800 may reference the above-mentioned computing resources of systems 100, 200. In some examples, the steps or actions of process 800 are enabled by programmed firmware instructions, software instructions, or both. Each type of instruction may be stored in a non-transitory machine-readable storage device and is executable by one or more of the processors or other resources described in this document, such as a scalar core or compute tile of a hardware accelerator or neural network processor.

In some implementations, the steps of process 800 are performed at a hardware integrated circuit to generate a ML output, including an output for a neural network layer of a neural network that implements the ML model. For example, the output can be a portion of a computation for a ML task or inference workload to generate an image processing, speech processing, or image recognition output. As indicated above, the integrated circuit can be a special-purpose neural network processor or hardware ML accelerator configured to accelerate computations for generating different types of data processing outputs.

Referring again to process 800, the system 100 monitors a processing instance using one or more cores of a controller (802). The processing instance can be a single processing instance of an example special-purpose integrated circuit for ML computations, such as ML hardware accelerator, neural network processor, or TPU. The processing instance can involve multiple tile clusters 110-n that operate concurrently, independently, or both.

The system 100 executes a first workload by a first cluster using compute tiles 202 of the first cluster (804). For example, the first tile cluster 110-0 can execute Workload-0 using compute tiles 202-0, 202-1, 202-2, 202-3. Concurrent with execution of the first workload, the system 100 executes a second workload at a second tile cluster using compute tiles 202 of the second cluster (806). For example, the second tile cluster 110-1 can execute Workload-1 using compute tiles 202-10, 202-11, 202-12, 202-13. The system 100 executes the first and second workloads concurrently based on a program context maintained by one or more scalar cores 112 that is instantiated by the controller (808).

The single processing instance can be used to execute multiple program contexts. The first and second workloads may be associated with the same program context or different program contexts. For example, Workload-0 and Workload-1 can be subtasks of an inference job for processing an input image. Pixels of the image can be represented as an input tensor that is passed to a cluster 106 (or clusters 106-n) for processing using tile clusters 110-0, 110-1. In some implementations, Workload-0 and Workload-1 are associated with the same program context and a joint/single program execution mode is used to execute concurrently the first and second workloads. For example, Workload-0 and Workload-1 can be executed concurrently to process pixel values for different dimensions of a multi-dimensional input tensor.

For joint/single execution of this image-processing job, the controller 104 can configure virtualized scalar cores 112-0, 112-1 in a particular manner. For example, the controller 104 can first preempt any existing programs running on tile clusters 110-0, 110-1. The controller 104 can then configure: i) scalar core 112-0 to forward data from bus outfeed connection 310-0 to its forwarding port (FP0) and ii) scalar core 112-1 to forward data from its receiving port (RP0) to its bus infeed connection 308-1. The controller 104 can also configure: i) scalar core 112-1 to forward data from its bus outfeed connection 310-1 to its forwarding port (FP1) and ii) scalar core 112-0 to consume data from its receiving ports (RP0 and RP1).

In some implementations, the concurrent execution of the Workload-0 and Workload-1 is based on time-multiplexed execution and task preemption of the first and second workloads. For example, each virtualized scalar core 112 is configured to: i) execute a low-priority workload comprising a first set of tasks; ii) pause executing the low-priority workload at a particular task of the first set of tasks; iii) execute a high-priority workload comprising a second set of tasks; and iv) after executing the high-priority workload, resume executing the low-priority workload at the particular task of the first set of tasks.

For each program context of the single processing instance, the controller 104 can determine or define a partition among memory resources of a tile cluster 110. The hardware features 312 of the virtualized scalar core 112 at tile cluster 110 can be included among the memory resources used to establish the partitions. The partitions are used by the virtualized scalar core 112 to execute task preemption in support of time-multiplexed execution of two or more program contexts, including a respective ML workload for each of the two or more program contexts.

For example, Workload-0 can be an existing low-priority workload, such as background or best-effort task, whereas Workload-1 is a new high-priority workload, such as real-time camera task or automatic speech recognition initiated by a user. The controller 104 can configure Workload-0 and Workload-1 for time-multiplexed execution at tile cluster 110-0. In this example, virtualized scalar core 112-0 will preempt Workload-0 (e.g., low-priority tasks) by pausing the workload, capturing/storing a hardware state of Workload-0, and executing a context switch to install a new program context for executing the new high-priority tasks of Workload-1.

In this example, the hardware state captured for the low-priority tasks of Workload-0 is stored using memory resources of a first partition defined at tile cluster 110-0, whereas execution of the new program context and new high-priority tasks of Workload-1 are supported by memory resources of a second, different partition defined at tile cluster 110-0. In this manner, the two or more workloads can be executed concurrently, or in a near concurrent manner, based on the rapid and iterative context switching for running time-multiplexed inferences.

The multiple execution of two or more workloads relates to the temporal parallelism afforded by the disclosed multi-cluster architecture, which allows for concurrent execution of multiple program contexts and ML workloads. For example, the multi-cluster processor 102 leverages the multi-context features, such as physical hardware features 312, of its virtualized scalar cores 112 to execute multiple program contexts per tile cluster 110-n. Executing the multiple program contexts can include maintaining multiple program/hardware states in support of context switching for task preemption.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network.

The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. An integrated circuit comprising:
a controller configured to communicate with one or more cores;
a first cluster comprising a first plurality of compute tiles, the first cluster being configured to execute a first workload using the first plurality of compute tiles; and
a second cluster comprising a second plurality of compute tiles, the second cluster being configured to execute a second workload using the second plurality of compute tiles;
wherein the first workload and the second workload are executed concurrently based on a program context of at least one core that is instantiated by the controller and that is coupled to the first and second plurality of compute tiles.

2. The integrated circuit of claim 1, wherein the controller is configured to execute a single processing instance in which the controller selects between:
a single execution mode to concurrently execute the first and second workloads; and
a joint execution mode to concurrently execute the first and second workloads.

3. The integrated circuit of claim 2, wherein the controller is further configured to:
determine whether the first and second workloads are the same workload; and
select the single execution mode to concurrently execute the first and second workloads in response to determining that the first and second workloads are the same workload.

4. The integrated circuit of claim 2, wherein the controller is further configured to:
determine whether the first and second workloads are different workloads; and
select the joint execution mode to concurrently execute the first and second workloads in response to determining that the first and second workloads are different workloads.

5. The integrated circuit of claim 1, wherein each of the one or more cores is configured to execute a plurality of program contexts and each program context corresponds to a particular workload.

6. The integrated circuit of claim 1, wherein:
each of the one or more cores is a virtualized scalar core configured for time-multiplexed execution of two or more program contexts; and
one or more virtualized scalar cores is assigned to the first cluster or the second cluster.

7. The integrated circuit of claim 6, further comprising:
a plurality of virtualized scalar cores, wherein each of the plurality of virtualized scalar cores is configured to execute a respective program context and is instantiated and managed based on control logic of the controller.

8. The integrated circuit of claim 6, wherein each virtualized scalar core is configured to support task preemption, comprising preempting a first task of the first workload to execute a second, different task of the second workload.

9. The integrated circuit of claim 6, wherein each virtualized scalar core is configured to:
execute a low-priority workload comprising a first plurality of tasks;
pause executing the low-priority workload at a particular task of the first plurality of tasks;
execute a high-priority workload comprising a second plurality of tasks; and
after executing the high-priority workload, resume executing the low-priority workload at the particular task of the first plurality of tasks.

10. The integrated circuit of claim 1, wherein the first cluster and the second cluster are homogeneous clusters comprising the same number of compute tiles.

11. The integrated circuit of claim 1, wherein the first cluster and the second cluster are heterogeneous clusters comprising a different number of compute tiles.

12. A method performed using an integrated circuit comprising a controller, a first cluster comprising a first plurality of compute tiles, and a second cluster comprising a second plurality of compute tiles, the method comprising:
monitoring, by the controller, a single processing instance executed at the integrated circuit using one or more cores that communicate with the controller;
during the single processing instance:
executing, by the first cluster, a first workload using the first plurality of compute tiles; and
concurrent with execution of the first workload, executing, by the second cluster, a second workload using the second plurality of compute tiles;
wherein the first workload and the second workload are executed concurrently based on a program context of at least one core that is instantiated by the controller and that is configured to communicate with the first and second plurality of compute tiles.

13. The method of claim 12, further comprising: during the single processing instance, selecting, by the controller, between:
a single execution mode to concurrently execute the first and second workloads; and
a joint execution mode to concurrently execute the first and second workloads.

14. The method of claim 13, further comprising:
determining, by the controller, whether the first and second workloads are the same workload; and
selecting, by the controller, the single execution mode to concurrently execute the first and second workloads in response to determining that the first and second workloads are the same workload.

15. The method of claim 13 further comprising:
determining, by the controller, whether the first and second workloads are different workloads; and
selecting, by the controller, the joint execution mode to concurrently execute the first and second workloads in response to determining that the first and second workloads are different workloads.

16. The method of claim 12, wherein each of the one or more cores is configured to execute a plurality of program contexts and each program context corresponds to a particular workload.

17. The method of claim 12, wherein:
each of the one or more cores is a virtualized scalar core configured for time-multiplexed execution of two or more program contexts; and
one or more virtualized scalar cores is assigned to the first cluster or the second cluster.

18. The method of claim 17, further comprising:
executing, by the controller, executing a respective program context at each virtualized scalar core of a plurality of virtualized scalar cores, wherein each of the plurality of virtualized scalar cores is instantiated and managed based on control logic of the controller.

19. The method of claim 17, wherein each virtualized scalar core is configured to support task preemption, comprising preempting a first task of the first workload to execute a second, different task of the second workload.

20. The method of claim 17, further comprising:
executing, by a virtualized scalar core of a cluster, a low-priority workload comprising a first plurality of tasks;
pausing, by the virtualized scalar core, executing the low-priority workload at a particular task of the first plurality of tasks;
executing, by the virtualized scalar core, a high-priority workload comprising a second plurality of tasks; and
after executing the high-priority workload, resuming, by the virtualized scalar core, executing the low-priority workload at the particular task of the first plurality of tasks.

21.-40. (canceled)
